(19) United States
(12) Patent Application Publication
(10) Pub. No.: US 2019/0042095 A1
(43) Pub. Date: Feb. 7, 2019

(54) MEMORY MODULE DESIGNED TO CONFORM TO A FIRST MEMORY CHIP SPECIFICATION HAVING MEMORY CHIPS DESIGNED TO CONFORM TO A SECOND MEMORY CHIP SPECIFICATION

(71) Applicant: Intel Corporation, Santa Clara, CA (US)

(72) Inventors: George VERGIS, Portland, OR (US); Bill NALE, Livermore, CA (US); Derek A. THOMPSON, Portland, OR (US); James A. McCALL, Portland, OR (US); Rajat AGARWAL, Portland, OR (US); Wei P. CHEN, Portland, OR (US)

(21) Appl. No.: 16/111,156

(22) Filed: Aug. 23, 2018

(51) Int. Cl. G06F 3/06

(52) U.S. Cl. CPC G06F 3/0604; G06F 3/0673; G06F 3/0659; G06F 3/0658

(57) ABSTRACT

An apparatus is described. The apparatus includes a memory controller having register space to inform the memory controller that the memory controller is coupled to a memory module that conforms to a first memory chip industry standard specification but is composed of memory chips that conform to a second, different memory chip industry standard specification.

### FIELD OF INVENTION

The field of invention pertains generally to a memory module designed to conform to a first memory chip specification having memory chips designed to conform to a second memory chip specification.

### BACKGROUND

The performance of computing systems is highly dependent on the performance of their system memory. Generally, however, increasing memory channel capacity and memory speed can result in challenges concerning the cost and/or time-to-market of the memory channel implementation. As such, system designers are seeking ways to increase memory channel capacity and bandwidth while keeping cost in check and/or ensuring newer technologies emerge into the marketplace in a timely fashion.

### FIGURES

A better understanding of the present invention can be obtained from the following detailed description in conjunction with the following drawings, in which:

FIG. 1 shows a first prior art DIMM;

FIG. 2 shows a second prior art DIMM;

FIG. 3a shows a third prior art DIMM;

FIG. 3b shows a first layout for a memory channel that interfaces with DIMMs of FIG. 3;

FIG. 3c shows a DDR4 DIMM;

FIG. 4a shows a DDR5 memory channel;

FIG. 4b shows a DDR5 DIMM;

FIG. 5a shows a DDR5 DIMM composed of DDR4 memory chips;

FIG. 5b shows a method of operation of the DIMM of FIG. 5a;

FIG. 6 shows a memory controller;

FIG. 7 shows a computing system.

### DETAILED DESCRIPTION

As is known in the art, main memory (also referred to as “system memory”) in high performance computing systems, such as high performance servers, are often implemented with dual in-line memory modules (DIMMs) that plug into a memory channel. Here, multiple memory channels emanate from a main memory controller and one or more DIMMs are plugged into each memory channel. Each DIMM includes a number of memory chips that define the DIMM's memory storage capacity. The combined memory capacity of the DIMMs that are plugged into the memory controller's memory channels corresponds to the system memory capacity of the system.

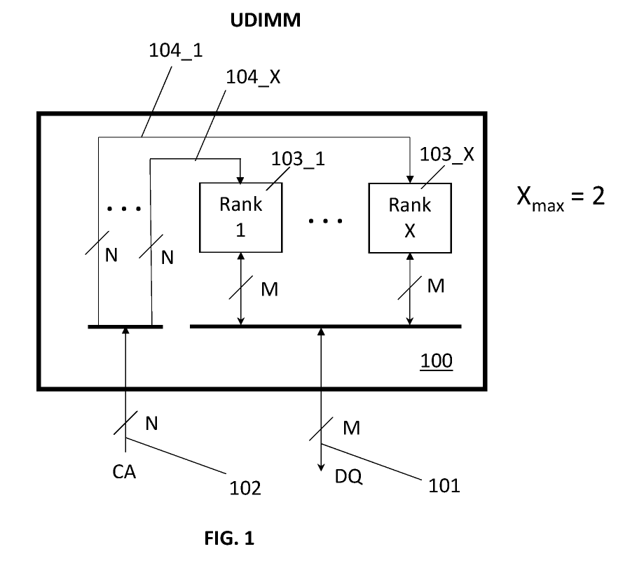

Over time the design and structure of DIMMs has changed to meet the ever increasing need of both memory capacity and memory channel bandwidth. FIG. 1 shows a traditional DIMM approach. As observed in FIG. 1, a single “unbuffered” DIMM (UDIMM) 100 has its memory chips directly coupled to the wires of the memory channel bus 101, 102. The UDIMM 100 includes a number of memory chips sufficient to form a data width of at least one rank 103. A rank corresponds to the width of the data bus which generally corresponds to the number of data signals and the number of ECC signals on the memory channel.

As such, the total number of memory chips used on a DIMM is a function of the rank size and the bit width of the memory chips. For example, for a rank having 64 bits of data and 8 bits of ECC, the DIMM can include eighteen “X4” (four bit width) memory chips (e.g., 16 chips×4 bits/chip=64 bits of data plus 2 chips×4 bits/chip to implement 8 bits of ECC), or, nine “X8” (eight bit width) memory chips (e.g., 8 chips×8 bits/chip=64 bits of data plus 1 chip×8 bits/chip to implement 8 bits of ECC).

For simplicity, when referring to FIG. 1 and the ensuing figures, the ECC bits may be ignored and the observed rank width M simply corresponds to the number of data bits on the memory bus. That is, e.g., for a data bus having 64 data bits, the rank=M=64.

UDIMMs traditionally only have storage capacity for two separate ranks of memory chips, where, one side of the DIMM has the memory chips for a first rank and the other side of the DIMM has the memory chips for a second rank. Here, a memory chip has a certain amount of storage space which correlates with the total number of different addresses that can be provided to the memory chip. A memory structure composed of the appropriate number of memory chips to interface with the data bus width (eighteen X4 memory chips or nine X8 memory chips in the aforementioned example) corresponds to a rank of memory chips. A rank of memory chips can therefore separately store a number of transfers from the data bus consistently with its address space. For example, if a rank of memory chips is implemented with memory chips that support 256 M different addresses, the rank of memory chips can store the information of 256 M different bus transfers.

Notably, the memory chips used to implement both ranks of memory chips are coupled to the memory channel 101, 102 in a multi-drop fashion. As such, the UDIMM 100 can present as much as two memory chips of load to each wire of the memory channel data bus 101 (one memory chip load for each rank of memory chips).

Similarly, the command and address signals for both ranks of memory chips are coupled to the memory channel's command address (CA) bus 102 in multi-drop form. The control signals that are carried on the CA bus 102 include, to name a few, a row address strobe signal (RAS), column address strobe signal (CAS), a write enable (WE) signal and a plurality of address (ADDR) signals. Some of the signals on the CA bus 102 typically have stringent timing margins. As such, if more than one DIMM is plugged into a memory channel, the loading that is presented on the CA bus 102 can sufficiently disturb the quality of the CA signals and limit the memory channel's performance.

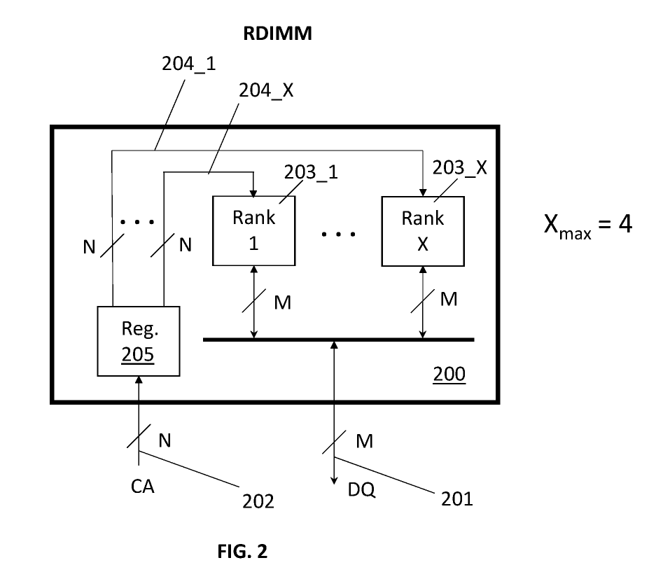

FIG. 2 shows a later generation DIMM, referred to as a register DIMM 200 (RDIMM), that includes register and redrive circuitry 205 to address the aforementioned limit on memory channel performance presented by loading of the CA bus 202. Here, the register and redrive circuitry 205 acts as a single load per DIMM on each CA bus 202 wire as opposed to one load per rank of memory chips (as with the UDIMM). As such, whereas a nominal dual rank UDIMM will present one load on each wire of the memory channel's CA bus 202 for memory chip on the UDIMM (because each memory chip on the UDIMM is wired to the CA bus 202), by contrast, a dual rank RDIMM with an identical set of memory chips, etc. will present only one chip load on each of the memory channel's CA bus 202 wires.

In operation, the register and redrive circuitry 205 latches and/or redrives the CA signals from the memory channel's CA bus 202 to the memory chips of the particular rank of memory chips on the DIMM that the CA signals are specifically being sent to. Here, for each memory access (read or write access with corresponding address) that is issued on the memory channel, the corresponding set of CA signals include chip select signals (CS) and/or other signals that specifically identify not only a particular DIMM on the channel but also a particular rank on the identified DIMM that is targeted by the access. The register and redrive circuitry 205 therefore includes logic circuitry that monitors these signals and recognizes when its corresponding DIMM is being accessed. When the logic circuitry recognizes that its DIMM is being targeted, the logic further resolves the CA signals to identify a particular rank of memory chips on the DIMM that is being targeted by the access. The register and redrive circuitry then effectively routes the CA signals that are on the memory channel to the memory chips of the specific targeted rank of memory chips on the DIMM 200.

A problem with the RDIMM 200, however, is that the signal wires for the memory channel's data bus 201 (DQ) are also coupled to the DIMM's ranks of memory chips 203_1 through 203_X in a multi-drop form. That is, for each rank of memory chips that is disposed on the RDIMM, the RDIMM will present one memory chip load on each DQ signal wire. Thus, similar to the UDIMM, the number of ranks of memory chips that can be disposed on an RDIMM is traditionally limited (e.g., to two ranks of memory chips) to keep the loading on the memory channel data bus 201 per RDIMM in check.

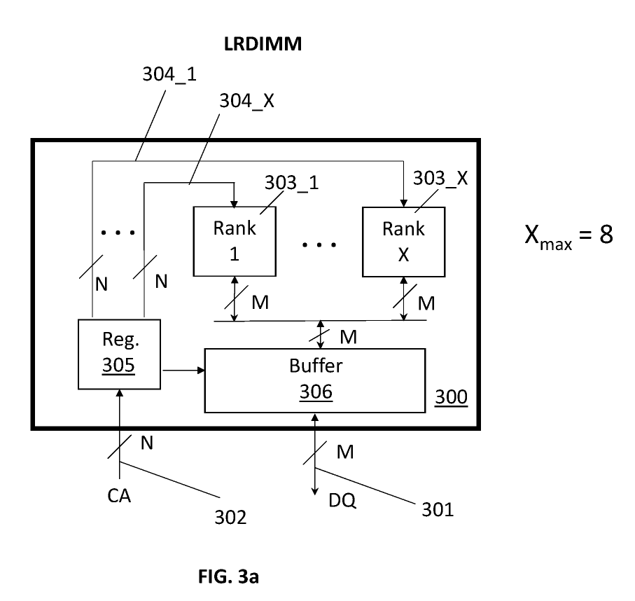

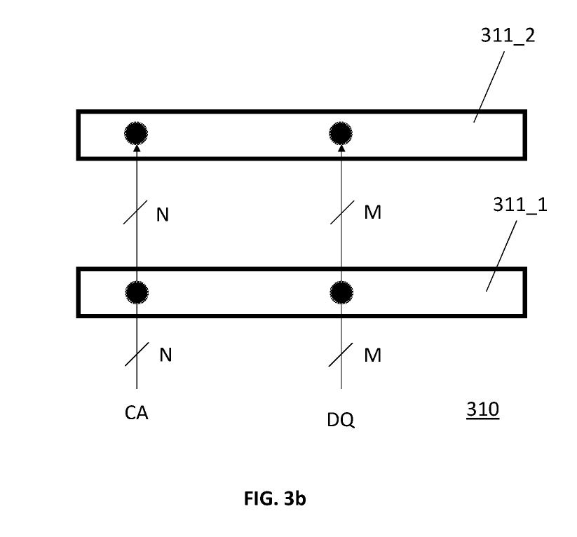

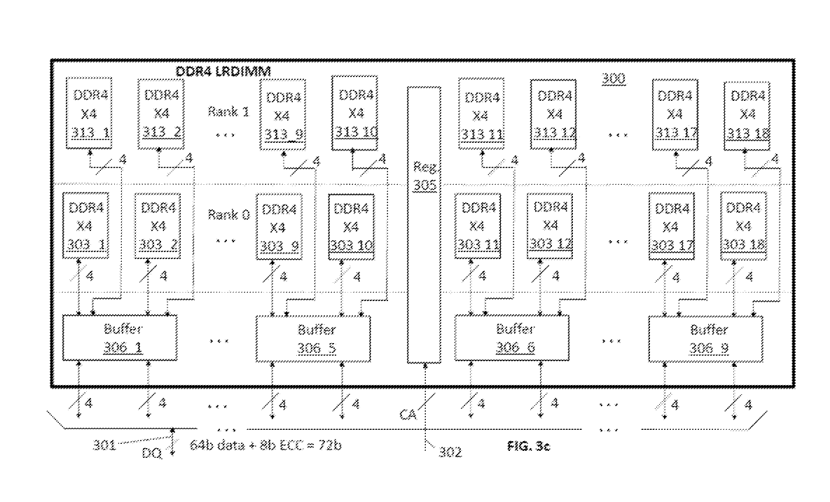

FIG. 3a shows an even later generation DIMM, referred to as a load reduced DIMM (LRDIMM) 300, in which both the CA bus wires 302 and the DQ bus wires 301 are presented with only a single load by the LRDIMM 300. Here, similar to the register and redrive circuitry of the RDIMM, the LRDIMM includes buffer circuitry 306 that stores and forwards data that is to be passed between the memory channel data bus 301 and the particular rank of memory chips 303 that is being targeted by an access. The register and redrive circuitry 305 activates whichever rank of memory chips is targeted by a particular access and the data associated with that access appears at the “back side” of the buffer circuitry 306.

With only a single point load for both the DQ and CA wires 301, 302 on the memory channel, the memory capacity of the LRDIMM 300 is free to expand its memory storage capacity beyond only two ranks of memory chips (e.g. four ranks on a single DDR4 DIMM). With more ranks of memory chips per DIMM and/or a generalized insensitivity to the number of memory chips per DIMM (at least from a signal loading perspective), new memory chip packaging technologies that strive to pack more chips into a volume of space have received heightened attention is recent years. For example, stacked chip packaging solutions can be integrated on an LRDIMM to form, e.g., a 3 Dimensional Stacking (3DS) LRDIMM.

Even with memory capacity per DIMM being greatly expanded with the emergence of LRDIMMs, memory channel bandwidth remains limited with LRDIMMs because multiple LRDIMMs can plug into a same memory channel. That is, a multi-drop approach still exists on the memory channel in that more than one DIMM can couple to the CA and DQ wires of a same memory channel.

Here, FIG. 3b shows a high performance memory channel layout 310 in which two DIMM slots 311_1, 311_2 are coupled to a same memory channel. The particular layout of FIG. 3b is consistent with the Joint Electron Device Engineering Council (JEDEC) Double Date Rate 4 (DDR4) memory standard. As can be seen from the layout 310 of FIG. 3b, if a respective LRDIMM is plugged into each of the two slots 311_1, 311_2, each CA bus wire and DQ bus wire will have two loads (one from each LRDIMM). If the loading could be further reduced, the timing margins of the CA and DQ signals could likewise be increased, which, in turn, would provide higher memory channel frequencies and corresponding memory channel bandwidth (read/write operations could be performed in less time).

FIG. 3c shows a more detailed depiction of a prior art DDR4 LRDIMM 300. The DDR4 LRDIMM of FIG. 3c has two ranks of memory chips. Specifically a first rank (rank_0) is composed of a lower row of “X4” memory chips 303_1 through 303_18. That is, eighteen X4 memory chips 303_1 through 303_18 are disposed (e.g., on a “front” side) on the DIMM to form the first rank (rank_0). Here, when ECC is considered, a DDR4 rank is composed of 64 data bits plus 8 bits ECC which corresponds to 72 total bits. Eighteen X4 memory chips are therefore needed to effect the 72 bits for a full rank (4 bits/memory chip×18 memory chips/rank=72 bits/rank). Another set of eighteen X4 memory chips 313_1 through 313_18 are disposed (e.g., on a “back” side) on the DIMM to form a second rank (rank_1).

Thus there are two independently accessible ranks of memory chips on the DIMM. In various approaches, chip select signal (CS) associated with the CA bus identifies which rank on the DIMM is being accessed for any particular access made to the DIMM 300. Buffer chips 306_1 through 306_9 couple whichever rank of chips is being accessed to the DQ bus. The register redriver circuitry 305 likewise routes/redrives control signals from the memory controller to the particular rank that is being accessed and sends appropriate control signals to the buffer circuits 306 so they couple the correct rank (the rank being accessed) to the DQ bus.

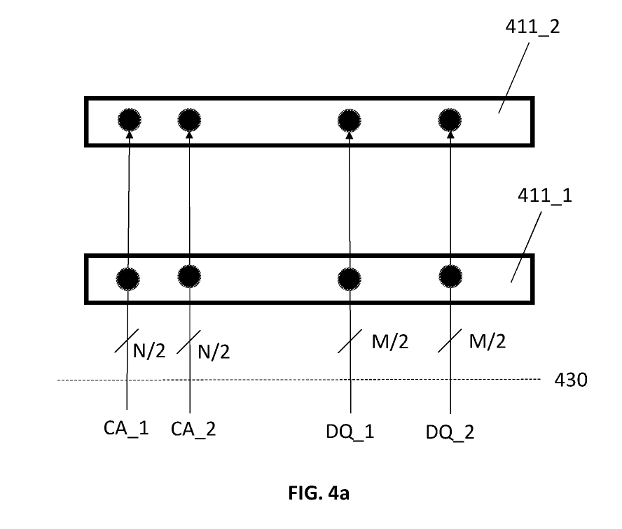

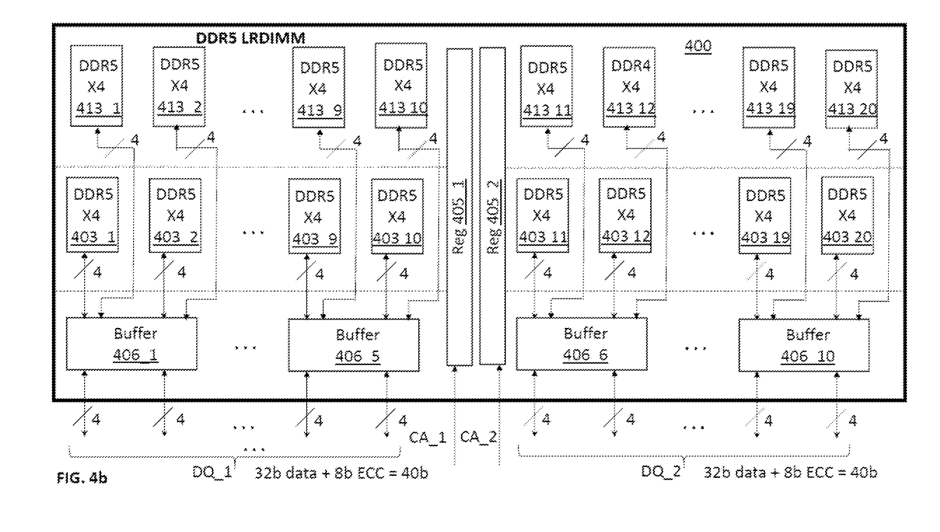

A next generation JEDEC memory interface standard, referred to as DDR5, is taking the approach of physically splitting both the CA bus and the DQ bus into two separate multi-drop busses as depicted in FIG. 4a. Here, comparing FIG. 3b with FIG. 4a, note that whereas the layout of FIG. 3b depicts a single N bit wide CA bus that is multi-dropped to two DIMM slots 311_1, 311_2 and a single M bit wide DQ data bus that is also multi-dropped to the two DIMM slots 311_1, 311_2; by contrast, the DDR5 layout of FIG. 4a consists of two separate N/2 bit wide CA busses that are multi-dropped to two DIMM slots 411_1, 411_2 and two separate M/2 bit wide DQ data busses that are multi-dropped to the DIMM slots 411_1, 411_2.

Again, for simplicity, ECC bits are ignored and M=64 in both FIGS. 3b and 4a for DDR4 and DDR5 implementations, respectively. As such, whereas DDR4 has a single 64 bit wide data bus, by contrast, DDR5 has two 32 bit wide data busses (DQ_1 and DQ_2). A “rank” in a DDR5 system therefore corresponds to 32 bits and not 64 bits (the width of both the DQ_1 and DQ_2 data busses is M/2=64/2=32 bits). Likewise, a rank of memory chips for a DDR5 system accepts 32 bits of data from a sub-channel in a single transfer rather than 64 as in DDR4. Unlike DDR4 which consumes eight data transfers in a burst read or write sequence to transfer a nominal cache line size of 512 bits (8 transfers/burst×64 bits/transfer=512 bits/burst), by contrast, in DDR5, sixteen data transfers are consumed on either sub-channel to transfer a nominal cache line size of 512 bits (16 transfers/burst×32 bits/transfer=512 bits/burst). The sub-channels operate independently in DDR5.

FIG. 4b shows a standard design for a DDR5 LRDIMM 400. As observed in the DDR5 LRDIMM of FIG. 4b, there are two ranks for each of the DQ_1 and DQ_2 sub-channels. Specifically X4 memory chips 403_1 through 403_10 form a first rank and X4 memory chips 413_1 through 413_10 form a second rank for the DQ_1 sub-channel. Likewise, X4 memory chips 403_11 through 403_20 form a first rank and X4 memory chips 413_11 through 413_20 form a second rank for the DQ_2 sub-channel. Here, the full width of each sub-channel is 40 bits when ECC bits are accounted for. That is the total bus width is 32 data bits plus eight bits ECC per sub-channel which corresponds to ten X4 memory chips per rank.

The two sub-channels operate independently, thus register and redriver circuitry 505_1 routes/redrives control signals to the appropriate one of the first and second ranks of the DQ_1 sub-channel as well as sends control signals to buffer chips 406_1 through 406_5 so that the correct one of these ranks is coupled to the DQ_1 bus. The “right half” of the LRDIMM operates the same/similarly as that described above for the “left half” of the LRDIMM except that the control and coupling of the first and second “right half” ranks is performed in relation to the DQ_2 bus instead of the DQ_1 bus.

Notably, comparing the detailed DDR4 LRDIMM of FIG. 3c with the detailed DDR5 LRDIMM of FIG. 4b, the DDR4 LRDIMM is composed of “DDR4” memory chips 303, 313 while the DDR5 LRDIMM is composed of “DDR5” memory chips 403, 413. Importantly, even though both the DDR4 and DDR5 memory chips have a same data width (4 bits=“X4”) they are nevertheless not compatible replacements for one another. That is, they are different memory chips that operate differently. Most significantly, whereas the DDR4 memory chips 303, 313 understand a burst sequence entails eight transfers, by contrast the DDR5 memory chips 403, 413 understand a burst sequence entails sixteen transfers. Again, for reasons explained at length above, whereas DDR4 transfers a nominal cache line's worth of information (512 bits) in eight data transfers, by contrast, DDR5 transfers a nominal cache line's worth of information in sixteen data transfers.

The DDR4 memory chips 303, 313 will therefore interpret a burst write command as a command in which eight consecutive write transfers are expected to be received from the memory controller, and, will issue eight consecutive read words in response to a burst read command. By contrast, DDR5 memory chips 403, 413 will interpret a burst write command as a command in which sixteen consecutive write transfers are expected to be received from the memory controller, and, will issue sixteen consecutive read words in response to a burst read command.

The DDR4 and DDR5 buffer chips 306, 406 are also different for similar reasons in that the DDR4 buffer chips 306 understand burst write commands to mean their respective DIMM will receive eight incoming transfers and understand burst read commands to mean their respective DIMM's memory chips 303/313 will send eight consecutive words. By contrast, DDR5 buffer chips 306 understand burst write commands to mean their respective DIMM will receive sixteen incoming transfers and understand burst read commands to mean their respective DIMM's memory chips 403/413 will send sixteen consecutive words.

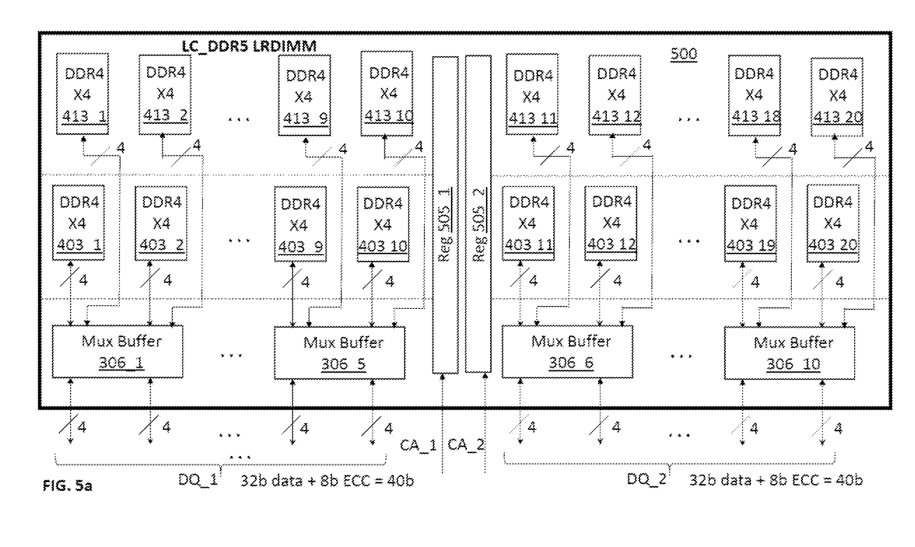

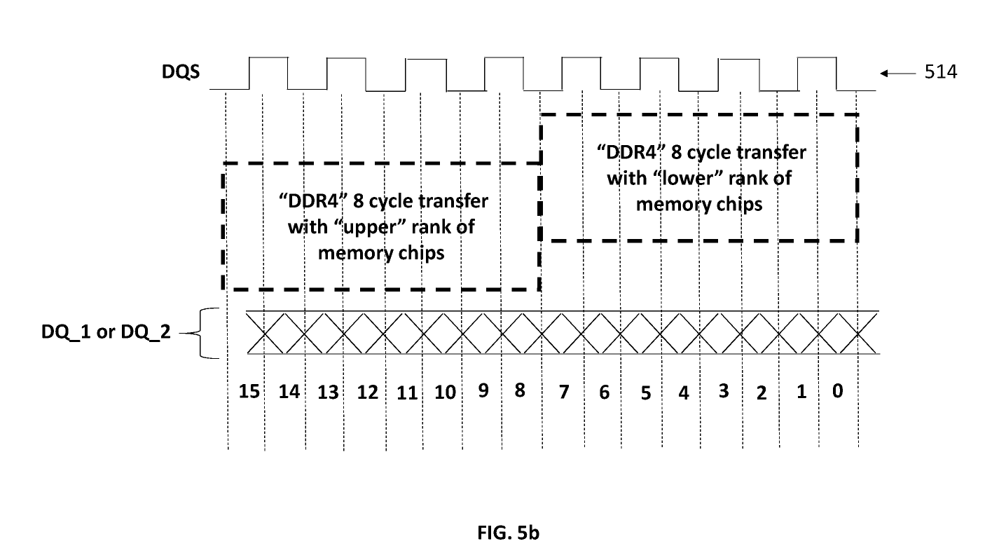

FIG. 5a shows a DDR5 LRDIMM 500 that is composed of DDR4 memory chips 503, 513 instead of DDR5 memory chips but that is nevertheless compliant with the DDR5 interface 430. That is, the DDR5 LRDIMM 500 operates as a DDR5 DIMM even though it contains DDR4 memory chips 503/513. Here, even though there are two ranks worth of memory chips per sub-channel from a data width perspective (on the left hand side, memory chips 403_1 through 403_10 form a first 40 bit wide rank's worth of memory chips and memory chips 413_1 through 413_10 form a second 40 bit wide rank's worth of memory chips, while, on the right hand side, memory chips 403_11 through 403_20 form a first 40 bit wide rank's worth of memory chips and memory chips 413_11 through 413_20 form a second 40 bit wide rank's worth of memory chips), the memory controller is nevertheless configured to access only one rank per sub-channel when accessing the LRDIMM 500 of FIG. 5a because both “ranks” per sub-channel are needed to fulfill sixteen transfer cycles per burst with the individual memory chips 503, 513 being designed to perform only eight transfers per burst.

FIG. 5b shows an exemplary burst read or write transfer for either the DQ_1 or DQ_2 sub-channels of the LRDIMM. As observed in FIG. 5b, a first group of the sub-channel's memory chips whose combined data width corresponds to the sub-channel's bus width (e.g., “lower” memory chips 503_1 through 503_10 for sub-channel DQ_1) execute eight transfers in burst mode to complete a front-half of a full DDR5 burst read or write, then, a second group of the sub-channel's memory chips whose combined data width corresponds to the sub-channel's bus width (e.g., “upper” memory chips 513_1 through 513_10 for sub-channel DQ_1) execute eight transfers in burst mode to complete the back-half of the full DDR5 burst read or write (and thereby complete the full DDRS burst mode transfer). Thus, a full DDR5 burst of sixteen transfers is effected by chaining in time two consecutive sets of eight transfers from two different sets of DDR4 memory chips. In particular, transfers to/from first and second memory chips are combined in time over a same wire on a DQ data bus.

As such, referring to FIGS. 5a and 5b, for any particular read or write burst access over either of the sub-channels, the corresponding register and redriver circuitry (e.g., circuitry 505_1 for the DQ_1 sub-channel or circuitry 505_2 for the DQ_2 sub-channel) first initiates an eight cycle burst transfer with the lower rank of memory chips (memory chips 503_1 through 503_10 for the DQ_1 sub-channel or memory chips 503_11 through 503_20 for the DQ_2 sub-channel) and then initiates an eight cycle burst transfer with the upper rank of memory chips (memory chips 513_1 through 513_10 for the DQ_1 sub-channel or memory chips 513_11 through 513_20 for the DQ_2 sub-channel). Additionally, when accessing the memory chips, the register redriver circuitry coverts incoming DDR5 signals into DDR4 signals (in order to properly access the DDR4 memory chips) which includes expanding the incoming signals from an N/2 width to an N width. Such conversion also generally entails SERDES (Serial/de-serialization) and clock and signal rate conversion by programmable ratios.

Likewise, the register and redriver circuitry controls the corresponding buffer chips 306 to correctly multiplex the pair of eight cycle transfers amongst the pair of ranks. That is, the register redriver circuitry will send control signals to the buffer chips 306 that cause the buffer chips 306 to first receive/send data over eight cycles from the lower rank of memory chips and then receive/send data over eight cycles from the upper rank of memory chips. As depicted in FIG. 5b, the buffer memory chips are multiplexing buffer chips that receive/data from two different ranks of memory chips over a same sixteen cycle DDR5 burst transfer.

It is pertinent to point out that the use of X4 memory chips specifically is exemplary. Other width memory chips may be used to the extent such other width memory chips are available (e.g., five X8 memory chips to form a lower rank and five X8 memory chips to form an upper rank). Moreover, it is possible to have a second independently addressable “rank” of memory on the DIMM by doubling the number of memory chip ranks on the DIMM as compared to the specific embodiment of FIG. 5b. For example, the aforementioned lower and upper ranks of memory chips can be viewed as first and second rows of memory chips.

As discussed at length above, the DIMM card support independent access to only one addressable rank of memory space because both the first and second rows operate cooperatively to effect full sixteen cycle DDR5 burst transfers. If third and fourth rows of memory chips were additionally added to the DIMM, the DIMM could support two different ranks of independently addressable memory space. In this case, for any particular read or write access directed to the DIMM over either of the sub-channels, the register and redriver circuitry 505 sends control signals to the correct pair of memory chip rows (the first and second rows, or, third and fourth rows). Likewise, the register and redriver causes the buffer circuitry to send/receive data to/from the correct pair of memory chip rows. Multi-die per package memory chip solutions (e.g., “dual die package”) may be used to help achieve these or other similar embodiments.

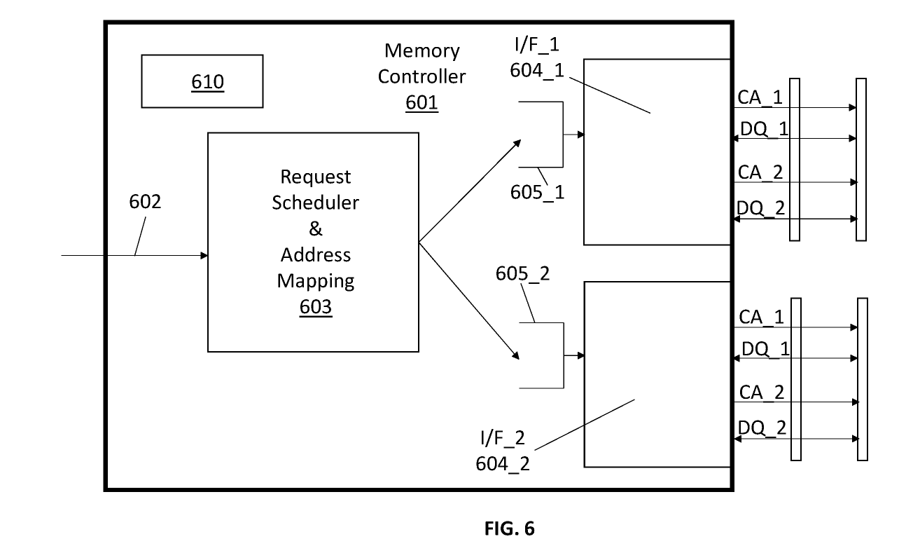

FIG. 6 shows an exemplary memory controller 601 that is capable of accessing the DIMM of FIG. 5b. The memory controller comprises first and second DDR5 memory interfaces 604_1, 604_2 that each comprise a pair of DQ point-to-point link interfaces for corresponding to a respective DIMM in a point-to-point fashion as discussed above. Each interface therefore includes first and second groups of input/outputs (I/Os) to respective couple to first and second DQ point-to-point links.

As observed in FIG. 6 the memory controller 601 receives memory read and memory write requests at input node 602. Scheduler and address mapping circuitry 603 orders and directs the requests to an appropriate DDR5 memory channel interface (e.g., DDR5 interface 604_1 or DDR5 interface 604_2). Notably, each memory channel interface includes its own address mapping logic circuitry (not shown in FIG. 6 for illustrative ease) to map each request to its correct sub-channel (said another way, the correct one of DQ_1 and DQ_2). As such, with two separate DQ channels, the memory interface circuitry 604_1/604_2 itself has to map the addresses of the requests it receives to a particular one of the DQ channels.

Here, an inbound queue 605_1, 605_2 precedes each interface 604_1, 604_2 and the address mapping circuitry of an interface may pull requests out-of-order from the queue to keep both sub-channels busy (e.g., if the front of the queue contains requests that map to only one of the DQ busses, the address mapping logic may pull a request from deeper back in the queue that maps to the other DQ channel).

Additionally, the memory controller 601 includes configuration register space 610 that has some consciousness as to whether or not the memory controller 601 is coupled to a DIMM like the DIMM of FIG. 5b. For example, the configuration register space 610 may include a setting that causes the memory controller 601 to understand there is only one ranks worth of addressable memory space on the DIMM. Moreover, the configuration register space 610 may also identify that certain configuration registers on the memory chips (e.g., mode register (MR) space) are not available. For instance, DDR5 contemplates that certain configuration options are available on the memory chips that are not available on DDR4 memory chips (examples include certain new refresh commands, CKE (Clock enable pin), ODT (On-Die termination). These signals will have to be decoded by the register on the DIMM based on the target Chip select and DRAM functional context. The configuration register space 610 therefore informs the memory controller 601 that the DDR5-specific configuration settings are not available on the memory chips of the DDR5 DIMM card that it is coupled to (because it has DDR4 memory chips). Conceivably, such register space 610 may permit/enable the memory controller 601 to access DDR4-specific configuration space on the memory chips that is not specified in the DDR5 standard (if DDR5 does not accommodate all register space requirements specified in the DDR4 standard).

Although embodiments above have contemplated a DDR5 DIMM with DDR4 memory chips, the overall invention should not construed as automatically being limited to this particular set of memory standards as conceivably the ideas expressed above may be more generally applied to memory modules that conform to a first set of memory requirements (e.g., a first industry standard specification) yet are constructed with memory chips that are designed to meet a second set of memory requirements (e.g., a second industry standard specification). Although embodiments above have contemplate a DIMM memory module specifically, in other embodiments a memory module other than a DIMM may be utilized (e.g., a stacked memory chip module).

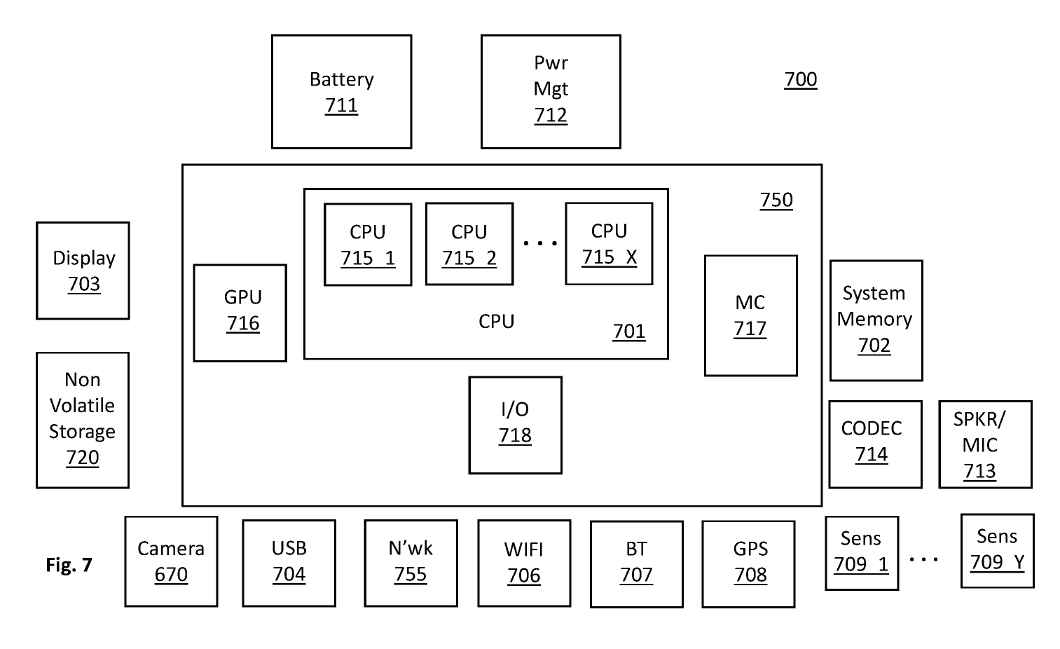

FIG. 7 provides an exemplary depiction of a computing system 700 (e.g., a smartphone, a tablet computer, a laptop computer, a desktop computer, a server computer, etc.). As observed in FIG. 7, the basic computing system 700 may include a central processing unit 701 (which may include, e.g., a plurality of general purpose processing cores 715_1 through 715_X) and a main memory controller 717 disposed on a multi-core processor or applications processor, system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_Y, one or more cameras 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller) and an I/O control function 718. The general purpose processing cores 715 typically execute the operating system and application software of the computing system. The graphics processing unit 716 typically executes graphics intensive functions to, e.g., generate graphics information that is presented on the display 703. The memory control function 717 interfaces with the system memory 702 to write/read data to/from system memory 702. The power management control unit 712 generally controls the power consumption of the system 700.

Each of the touchscreen display 703, the communication interfaces 704-707, the GPS interface 708, the sensors 709, the camera(s) 710, and the speaker/microphone codec 713, 714 all can be viewed as various forms of I/O (input and/or output) relative to the overall computing system including, where appropriate, an integrated peripheral device as well (e.g., the one or more cameras 710). Depending on implementation, various ones of these I/O components may be integrated on the applications processor/multi-core processor 750 or may be located off the die or outside the package of the applications processor/multi-core processor 750. The computing system also includes non-volatile storage 720 which may be the mass storage component of the system.

The main memory control function 717 (e.g., main memory controller, system memory controller) may be designed consistent with the teachings above including an ability utilize a memory module that is designed to conform to a first memory chip industry standard specification but whose memory chips conform to a second, different memory chip industry standard specification.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., field programmable gate array (FPGA), programmable logic device (PLD)) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory controller having register space to inform the memory controller that the memory controller is coupled to a memory module that conforms to a first memory chip industry standard specification but is composed of memory chips that conform to a second, different memory chip industry standard specification.

2. The apparatus of claim 1 wherein the first memory chip industry standard specification is DDR5 and the second memory chip industry standard specification is DDR4.

3. The apparatus of claim 2 wherein the memory module is a DIMM.

4. The apparatus of claim 1 wherein the register space includes first register space that causes the memory controller to not attempt to access memory chip register space of the memory chips that is defined in the first memory chip industry standard specification but is not defined in the second memory chip industry standard specification.

5. The apparatus of claim 4 wherein the first register space prohibits the memory controller from applying a refresh to the memory chips that is defined in the first memory chip industry standard specification but is not defined in the second memory chip industry standard specification.

6. An apparatus, comprising:
a memory module that is designed to conform to a first memory chip industry standard specification but is composed of memory chips that conform to a second, different memory chip industry standard specification, the first memory chip industry standard defining a first number of transfer cycles during a transfer sequence that is greater than a second number of transfer cycles during a transfer sequence defined by the second memory chip industry standard specification, the memory module designed to fulfill the second number of transfer cycles by combining transfers of first and second different ones of the memory chips along a same wire of a memory bus.

7. The apparatus of claim 6 wherein the first memory chip industry standard specification is DDR5 and the second memory chip industry standard specification is DDR4.

8. The apparatus of claim 7 wherein the memory module is a DIMM.

9. The apparatus of claim 6 wherein the memory module comprises buffer circuitry to multiplex the transfers on the same wire.

10. The apparatus of claim 6 wherein the memory module comprises redriver circuitry to convert commands of the first memory chip industry standard specification to the second memory chip industry standard specification and send the converted commands to the memory chips.

11. A computing system, comprising:
a plurality of processing cores;
a networking interface;
a memory controller having register space to inform the memory controller that the memory controller is coupled to a memory module that conforms to a first memory chip industry standard specification but is composed of memory chips that conform to a second, different memory chip industry standard specification.

12. The apparatus of claim 11 wherein the first memory chip industry standard specification is DDR5 and the second memory chip industry standard specification is DDR4.

13. The apparatus of claim 12 wherein the memory module is a DIMM.

14. The apparatus of claim 11 wherein the register space includes first register space that causes the memory controller to not attempt to access memory chip register space of the memory chips that is defined in the first memory chip industry standard specification but is not defined in the second memory chip industry standard specification.

15. The apparatus of claim 14 wherein the first register space prohibits the memory controller from applying a refresh to the memory chips that is defined in the first memory chip industry standard specification but is not defined in the second memory chip industry standard specification.
